(19) United States
(12) Patent Application Publication
(10) Pub. No.: US 2025/0258687 A1
(43) Pub. Date: Aug. 14, 2025

(54) DYNAMIC-AI-DRIVEN SYSTEMS AND METHODS FOR ENHANCING APPLICATION LOGIC

(71) Applicant: Alan AI, Inc., Sunnyvale, CA (US)

(72) Inventors: Andrey Ryabov, Sunnyvale, CA (US); Ramu V. Sunkara, Los Altos, CA (US); Anna Miroshnichenko, Chelyabinsk (RU)

(21) Appl. No.: 19/048,726

(22) Filed: Feb. 7, 2025

Related U.S. Application Data
(60) Provisional application No. 63/552,072, filed on Feb. 9, 2024.

(51) Int. Cl. G06F 9/451; G06F 8/38; G06F 40/30

(52) U.S. Cl. CPC G06F 9/451; G06F 8/38; G06F 40/30

(57) ABSTRACT

A computer-implemented method for enhancing application logic may include receiving, by an artificial intelligence (AI) agent, a query from a user; processing, by the AI agent, the query to derive an intent; building, by the AI agent, an execution plan based on the intent; retrieving, by the AI agent, in accordance with the execution plan, data from one or more data sources; processing, by the AI agent, the data via one or more transforms in accordance with the execution plan; and returning, by the AI agent, a result based on output produced by the one or more transforms. Various other methods, systems, and computer-readable media are also disclosed.

### CROSS-REFERENCE TO RELATED APPLICATIONS

This application claims the benefit of priority under 35 U.S.C. § 119 (e) of U.S. Provisional Application No. 63/552,072, filed 9 Feb. 2024, the contents of which is incorporated herein by reference in its entirety.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a flow diagram of an exemplary method for dynamic artificial intelligence (AI)-driven systems for enhancing application logic.

FIG. 2 is a block diagram of an exemplary execution plan for dynamic AI-driven systems and methods for enhancing application logic.

FIG. 3 is a flow diagram of an exemplary recursive execution plan for dynamic AI-driven systems and methods for enhancing application logic.

FIG. 4 is a block diagram of exemplary components for dynamic AI-driven systems and methods for enhancing application logic.

FIG. 5 is a flow diagram of an exemplary system for dynamic AI-driven systems and methods for enhancing application logic.

FIG. 6 is a flow diagram of exemplary UI elements generation for dynamic AI-driven systems and methods for enhancing application logic.

FIG. 7 is a flow diagram of an exemplary human-in-the-loop method to improve intelligence in a dynamic AI-driven system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION

The present disclosure is generally directed to dynamic AI-driven systems and methods for enhancing application logic. There are typically three major components of an application: user interface (UI), Application/Business Logic, and application programming interface (API)/Data Sources. The systems and methods described herein target the challenge of inflexible and brittle business logic layer in enterprise software, which is typically hardcoded and slow to adapt to new needs. Traditional software designs have a business logic layer that processes requests and interacts with data but often becomes a bottleneck due to its stiffness and the complexity of modifying it for new business rules. This leads to three problems: (i) Difficulty in adapting to new requirements: changing hardcoded business logic to fit evolving needs is slow and error prone, (ii) Maintenance challenges: updating business logic for changes or new functionalities requires significant developer time and resources, and (iii) Scalability issues: hardcoded business logic restricts an application's ability to scale with increasing complexity and organizational size. The systems and methods described herein focus on dynamically generating business logic from user inputs via graphical user interface (GUI) and/or chat interfaces, aiming to make enterprise software more flexible and easier to update or add new features and dynamically generate UI elements for responses. This method plans to replace the old, rigid business logic layer with a fluid, AI-driven system that processes requests in real time, tackling the issues of stiffness and fragility in software architecture.

Moreover, these systems can address issues in developing and using Large Language Models (LLMs) in complex systems like enterprise applications. These problems can include problems in creating effective prompts for desired outputs and “hallucinations” from LLMs, where outputs may be inaccurate or irrelevant, and the necessity for a system that can understand and process real-time queries related to dynamic data sources like databases or APIs. By employing innovative corpora and transforms, the system offers a more dynamic and adaptable framework for AI systems. This approach lessens dependence on hardcoded business logic, eases the interaction with dynamic data sources, and reduces instability seen with traditional LLMs, facilitating the development and upkeep of advanced applications capable of supporting various user actions and queries effectively.

The systems and methods described herein operate using a framework based on three main concepts: intents, corpora, and transforms. Together, these concepts enable the creation of intelligent conversational applications.

### Intents

Intents identify and interpret user actions or desires within the system. For example, in an application, an intent may be related to a user's wish to create, alter, or remove a rule or policy. The system recognizes these intents to understand and act upon the user's specific request. The intent of a user in generative AI is their goal or purpose for interacting with a computer system. This can be a simple task such as looking up information or making a purchase, or a more complex interaction such as scheduling an appointment or configuring a new device.

### Corpora:

Corpora act as knowledge interfaces within the system, categorized by functionality and data type. They range from static, dynamic, hybrid, to custom, based on the data source and its nature. Static corpora may use crawlers for data from set sources, while dynamic corpora may interact with live data, such as API calls, providing real-time information in response to queries. Static corpora utilize predefined data sources, often crawled from specific URLs and stored for later retrieval. Dynamic corpora acquire real-time data from external APIs or databases, ensuring that information is current. Hybrid or custom-defined corpora merge static and dynamic features or introduce new functionalities for particular needs.

### Transforms:

Transforms are a layer over the LLMs tailored to overcome traditional LLM issues like prompt engineering difficulties, instability, and response inaccuracies. They may process inputs from user interactions (intents) and data from corpora to produce contextually relevant, coherent, and accurate responses regardless of the underlying LLM. Transforms leverage the LLMs to convert input data and queries into user-understandable information, closing the gap between raw data and actionable insights. They may also transform data from corpora into actionable insights or responses with reasoning.

In one example of an operational flow, the system identifies relevant intents following user interaction, directing the query to the appropriate corpus or corpora. Corpora then retrieve necessary data, which may involve database queries, web crawling, or API calls. This data is processed by transforms, which generate a human-readable response or execute an action in the system.

The system's design allows it to dynamically learn from interactions, enhancing its accuracy and efficiency. It offers transparency in reasoning steps, letting users see and adjust the execution paths. In one embodiment, all execution code may be generated in JavaScript, ensuring the system's adaptability across various use cases without relying heavily on hardcoded logic.

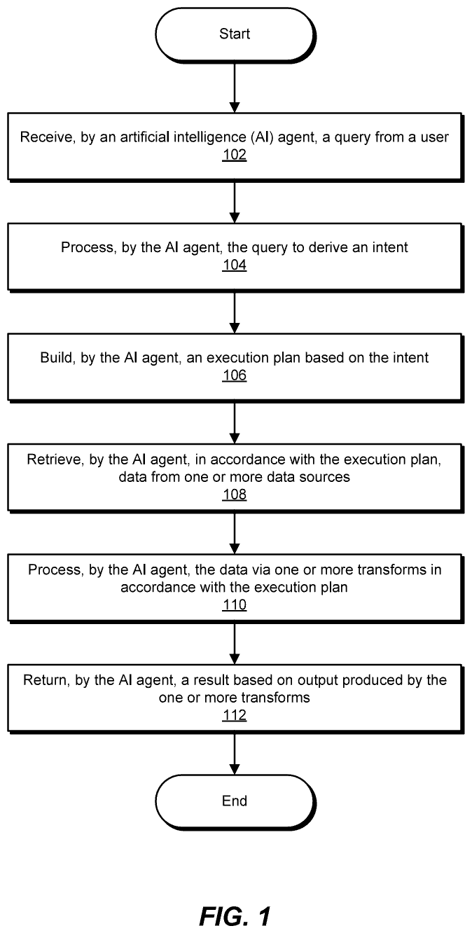

In some examples, the systems described herein may receive and respond to queries from users. For example, as illustrated in FIG. 1, at step 102, the systems described herein may receive, an AI agent, a query from a user. In some examples, the systems described herein may receive a text-based query in a chat window. In some examples, a query may be a request for information, such as, “why are human resources employees unable to log in?” while in other examples the query may be a request for an action, such as, “merge the users in group A into group B.”

At step 104, the systems described herein may process, by the AI agent, the query to derive an intent. For example, the systems described herein may identify the information the user is seeking and/or the action the user would like to take.

At step 106, the systems described herein may build, by the AI agent, an execution plan based on the intent. In some examples, the systems described herein may build the execution plan recursively by breaking the problem down into discrete steps, then breaking each step down into discrete sub-steps, breaking each sub-step down further, and so forth, until the lowest-level sub-step is a block of code.

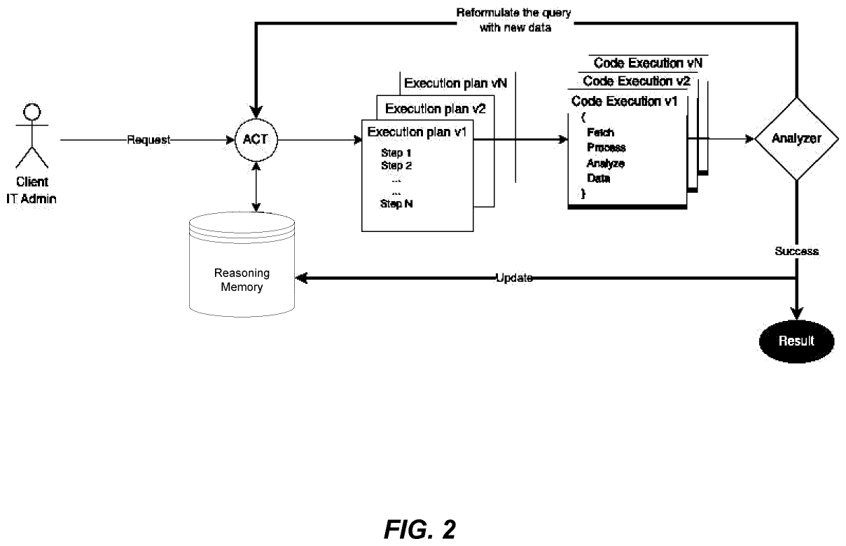

In some embodiments, the systems described herein may generate multiple execution plans and determine the most efficient and/or effective execution plan. For example, as illustrated in FIG. 2, the systems described herein may generate a set of execution plans, generate code for each execution plan, then analyze the code to refine and/or select one or more of the execution plans for further refinement and/or execution. In some examples, the systems described herein may reformulate the query from the user over the course of refining one or more execution plans.

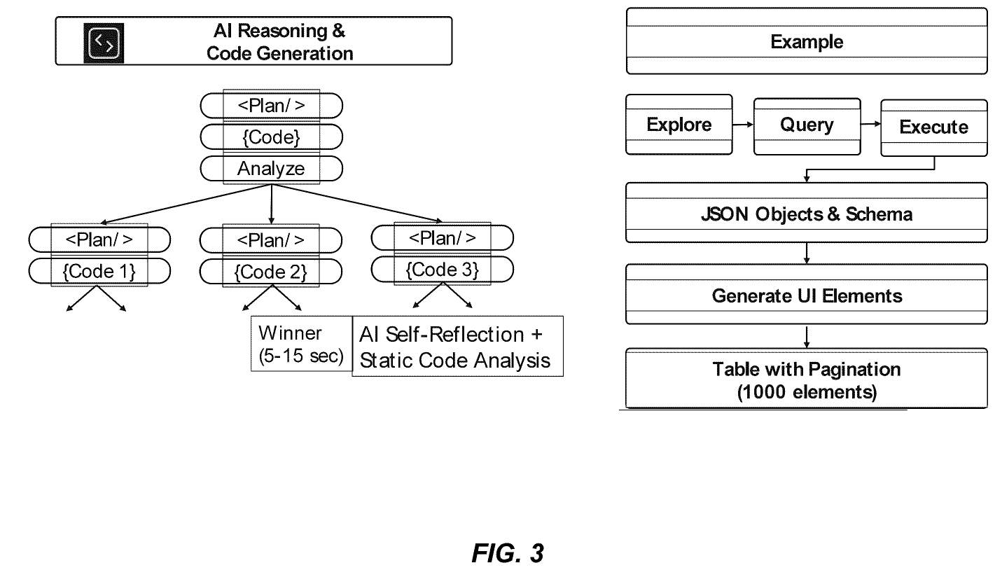

The systems described herein may analyze the execution plans in a variety of ways. For example, as illustrated in FIG. 3, the systems described herein may use AI self-reflection and/or static code analysis to analyze the execution plans. Additionally, or alternatively, the systems described herein may estimate, calculate, and/or measure the execution time of an execution plan. For example, the execution time to perform a query and then generate a UI element paginated table with one thousand elements may be non-trivial, so it may be beneficial for the systems described herein to select an execution plan with a high degree of efficiency. In some embodiments, the systems described herein may save an execution plan for later usage. For example, suppose the systems described herein develops a highly efficient execution plan to query and build a table from a large dataset. In that case, the systems described herein may save this plan for future similar queries, enabling the AI agent to skip or simplify the execution-plan-generation step by using the previously generated execution plan as the basis of the execution plan for the future query.

In some embodiments, the systems described herein may provide users with visibility into the execution plan. In one embodiment, they offer a UI that allows users to modify the execution plan. This feature is known as the human-in-the-loop capability, enhancing accuracy and making the system more intelligent. For example, it may allow users to rewrite code and create, delete, or modify steps of the execution plan.

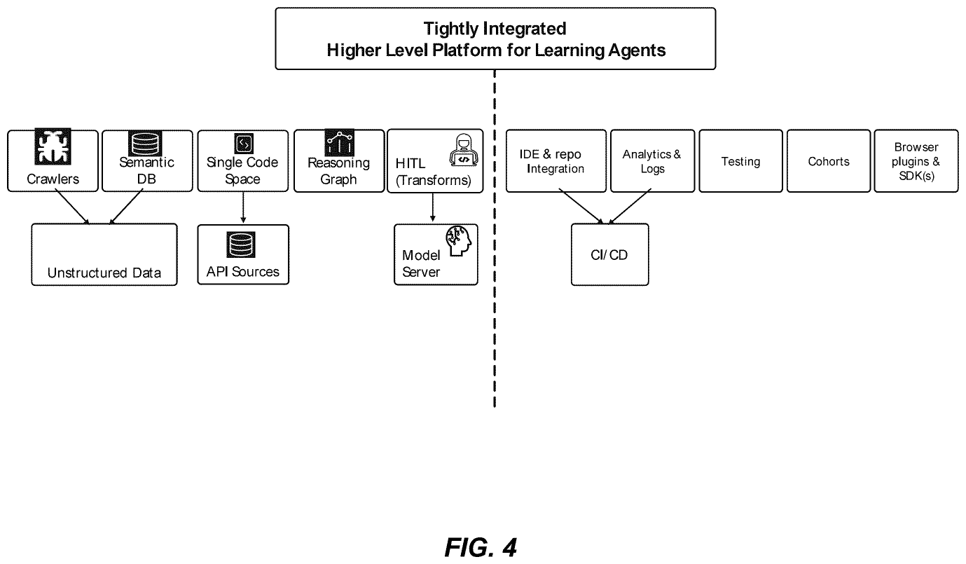

Returning to FIG. 1, at step 108, the systems described herein may retrieve, by the AI agent, in accordance with the execution plan, data from one or more data sources. In some embodiments, the systems described herein may retrieve data from a combination of static and/or dynamic data sources (e.g., corpuses as described above). For example, as illustrated in FIG. 4, the systems described herein may pull from the Semantic Database for static data and use the Single Code Space to retrieve dynamic data using APIs.

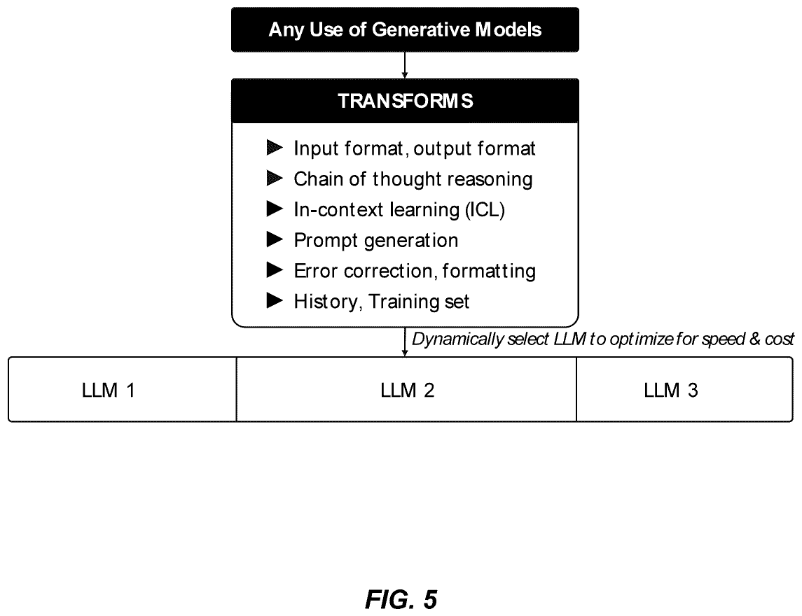

Returning to FIG. 1, at step 110, the systems described herein may process, by the AI agent, the data via one or more transforms in accordance with the execution plan. In some embodiments, the transforms may convert the raw information into an understandable and useful format for the user. In some examples, this step may be where the bulk of the processing happens, turning data into coherent responses or actions. In some examples, as illustrated in FIG. 5, the systems described herein may select one or more LLMs from a set of available LLMs (e.g., LLMs provided by different vendors with different strengths and weaknesses) based on the task. The Transforms technology is invented to eliminate manual prompt engineering, ensuring consistent input and outputs from LLMs. They provide the stability and predictability from LLMs for any Application.

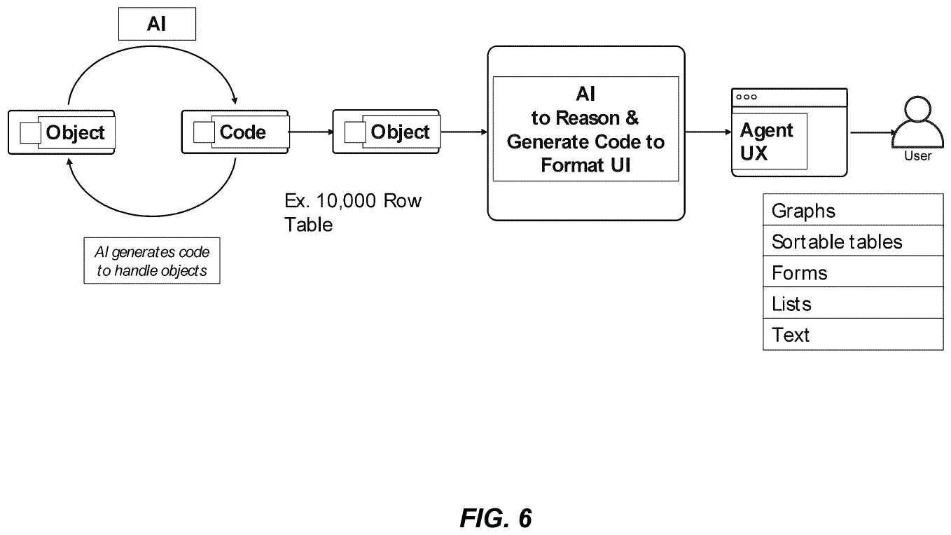

At step 112, the systems described herein may return, by the AI agent, a result based on output produced by the one or more transforms. The AI agent may return a result in many formats. For example, as illustrated in FIG. 6, the AI agent may generate appropriate user interface elements that include graphs, sortable tables, forms, lists, text, and/or other types of content.

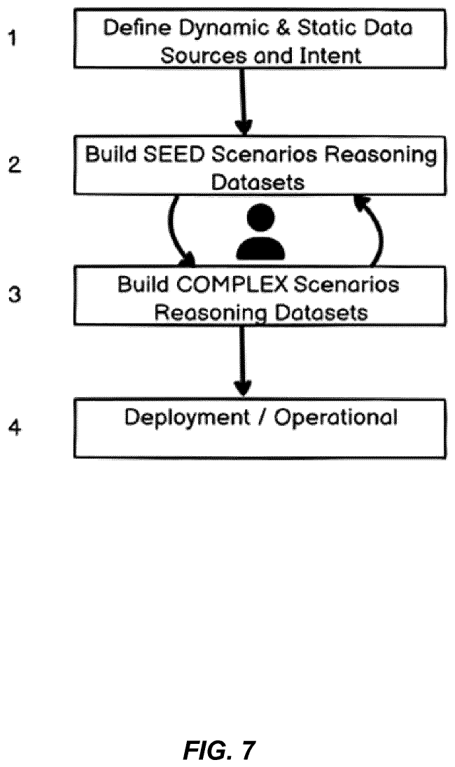

In some embodiments, the systems described herein may be trained and/or initialized before accepting queries from users. FIG. 7 illustrates an example of the system's operational process. At step 1, the system undergoes initialization. The developer specifies static and dynamic data sources and defines specific intents for the application. At steps 2 and 3, the system undergoes iteration and learning. This is also known as human-in-the-loop to improve the accuracy and intelligence of the system. Through iterative cycles, the system is taught using reasoning data sets. Developers begin with straightforward scenarios, manually generating code and adjusting the system's output as necessary. In some examples, the developer starts with simple scenarios and corrects the output to educate the system by showing the reasoning steps. The system can also undergo interactive tuning. The system's dynamic learning capability allows it to interpolate from simple to more complex examples based on user or developer interactions. This process includes correcting errors and refining the system's understanding and responses. Finally, at step 4, the system undergoes operational deployment. With the iterative learning and tuning process complete, the system for application business logic becomes fully operational, capable of handling a wide range of user interactions with increased accuracy and efficiency.

Throughout this process, the system's reasoning steps are transparent and traceable, allowing users to see and adjust how decisions are made and how code is generated. This iterative, interactive approach ensures continuous improvement and adaptation of the system to meet specific application needs without the requirement for traditional model fine-tuning.

In addition, transforms technology utilizes transforms with reasoning, an advancement over LLMs, to overcome issues like prompt engineering complexity, system instability, and inaccurate outputs. This technology ensures more reliable and consistent response generation, a significant improvement over the unpredictability of traditional LLMs. Prompt engineering offers improvements in that traditional LLM deployment requires users or UI engineers to precisely craft prompts to execute specific API calls or database queries, a task often beyond their expertise. This system may eliminate such complexities, enabling the system to understand and generate the correct prompt code without requiring intricate prompt crafting from the user. That is, auto generation of prompt to get desired results as per the intent and corpus data. By performing dynamic handling of user intents interprets and categorizing user actions through intents, the systems described herein may offer a more adaptable and intuitive user interaction model that evolves with user needs.

In some examples, the system may learn from user interactions and automatically adjust its responses, reducing or eliminating the need for constant retraining or manual updates. This continuous real-time improvement may ensure sustained effectiveness despite changing user requirements and external conditions. By providing clear insights into the reasoning behind each response, including data retrieval and transformation processes, the system may offer a level of transparency and debuggability rare in similar technologies. By dynamically generating business logic from user queries, the system drastically reduces the need for hardcoded logic layers, streamlining development, maintenance, and updates.

These innovative features underscore a novel approach to conversational AI, delivering a more adaptable, reliable, and user-centric solution than current technologies for web and mobile applications.

In some embodiments, the systems described herein may be configured to undergo modifications or variations to broaden its applicability and enhance its functionality across diverse settings. For example, the system can be tailored to meet the unique challenges and requirements of various industries, such as healthcare, finance, or retail, by customizing corpora and transforms to process industry-specific terminology and data sources effectively. Integrating more transforms enables the system to adapt dynamically to new information, user feedback, and changing conditions, minimizing the need for manual adjustments. Additionally, expanding the system to support multiple languages, caters to a global audience by training the system on a wide range of linguistic data sets.

In some examples, adding advanced personalization capabilities may make the system's interactions more relevant and engaging for users by tailoring responses to individual preferences, history, and context. In one embodiment, the system may operate in offline modes for certain functions, enabling users to access essential information or perform specific tasks without needing an internet connection. In some examples, incorporating detailed analytics and reporting functionalities may offer insights into user interactions, evaluate system performance, and/or identify opportunities for enhancement, supporting strategic decisions. These enhancements and adjustments may significantly increase the invention's utility and versatility, making it an invaluable asset for many use cases and user requirements.

The systems and methods described herein have a number of potential practical applications. This technology can enhance mobile and web applications in various areas. The system can be tailored to meet the unique challenges and requirements of various industries, such as healthcare, finance, or retail, by customizing corpora and transforms to process industry-specific terminology and data sources effectively. The system can integrate more advanced transforms and Large Language Models to enable the system to adapt more dynamically to new information, user feedback, and changing conditions, minimizing the need for manual adjustments. The system can be expanded to support multiple languages, catering to a global audience by training it on a wide range of linguistic data sets. The system can add advanced personalization capabilities to make the system's interactions more relevant and engaging for users by tailoring responses to individual preferences, history, and context. Features can be developed that allow the system to operate in offline modes for certain functions, enabling users to access essential information or perform specific tasks without needing an internet connection. Incorporating detailed analytics and reporting functionalities can enable the system to offer insights into user interactions, evaluate system performance, and identify opportunities for enhancement, supporting strategic decisions. These enhancements and adjustments could significantly increase the system's utility and versatility, making it an invaluable asset for a wide array of use cases and user requirements.

In some aspects, the techniques described herein relate to a computer-implemented method including: receiving, by an AI agent, a query from a user; processing, by the AI agent, the query to derive an intent; building, by the AI agent, an execution plan based on the intent; retrieving, by the AI agent, in accordance with the execution plan, data from one or more data sources; processing, by the AI agent, the data via one or more transforms in accordance with the execution plan; and returning, by the AI agent, a result based on output produced by the one or more transforms.

In some aspects, the techniques described herein relate to a method, wherein returning the result includes presenting the processed data to the user.

In some aspects, the techniques described herein relate to a method, wherein returning the result includes dynamically building, by the AI agent, a graphical user interface to be displayed to the user.

In some aspects, the techniques described herein relate to a method, wherein returning the result includes dynamically generating, by the AI agent, at least one image to present to the user.

In some aspects, the techniques described herein relate to a method, wherein returning the result includes performing a computing action.

In some aspects, the techniques described herein relate to a method, wherein building the execution plan includes recursively building the execution plan by: building a high-level execution plan including a plurality of steps; and recursively building an execution plan for each step in the plurality of steps.

In some aspects, the techniques described herein relate to a method, further including providing the execution plan to the user.

In some aspects, the techniques described herein relate to a method, wherein providing the execution plan to the user includes providing a user interface that enables the user to modify the execution plan.

In some aspects, the techniques described herein relate to a method, further including providing the one or more transforms to the user.

In some aspects, the techniques described herein relate to a method, wherein providing the one or more transforms to the user includes providing a user interface that enables the user to modify the one or more transforms.

In some aspects, the techniques described herein relate to a method, wherein the one or more data sources include at least one application programming interface.

In some aspects, the techniques described herein relate to a method, wherein building the execution plan includes: building a plurality of execution plans; testing each execution plan in the plurality of execution plans; and selecting a highest-performing execution plan as the execution plan.

In some aspects, the techniques described herein relate to a method, further including storing the highest-performing execution plan.

In some aspects, the techniques described herein relate to a method, wherein: building the execution plan includes generating computing code; retrieving the data from one or more data sources includes executing a portion of the computing code; and processing the data via one or more transforms includes executing an additional portion of the computing code.

In some aspects, the techniques described herein relate to a system including: at least one physical processor; physical memory including computer-executable instructions that, when executed by the physical processor, cause the physical processor to: receive, by an AI agent, a query from a user; process, by the AI agent, the query to derive an intent; build, by the AI agent, an execution plan based on the intent; retrieve, by the AI agent, in accordance with the execution plan, data from one or more data sources; process, by the AI agent, the data via one or more transforms in accordance with the execution plan; and return, by the AI agent, a result based on output produced by the one or more transforms.

In some aspects, the techniques described herein relate to a system, wherein returning the result includes presenting the processed data to the user.

In some aspects, the techniques described herein relate to a system, wherein returning the result includes dynamically building, by the AI agent, a graphical user interface to be displayed to the user.

In some aspects, the techniques described herein relate to a system, wherein returning the result includes dynamically generating, by the AI agent, at least one image to present to the user.

In some aspects, the techniques described herein relate to a system wherein returning the result includes performing a computing action.

In some aspects, the techniques described herein relate to a non-transitory computer-readable medium including one or more computer-readable instructions that, when executed by at least one processor of a computing device, cause the computing device to: receive, by an AI agent, a query from a user; process, by the AI agent, the query to derive an intent; build, by the AI agent, an execution plan based on the intent; retrieve, by the AI agent, in accordance with the execution plan, data from one or more data sources; process, by the AI agent, the data via one or more transforms in accordance with the execution plan; and return, by the AI agent, a result based on output produced by the one or more transforms.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure. Logistics and receiving personnel can later view these logs to verify that the cap lock system is being used correctly.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by an artificial intelligence (AI) agent, a query from a user;
processing, by the AI agent, the query to derive an intent;
building, by the AI agent, an execution plan based on the intent;
retrieving, by the AI agent, in accordance with the execution plan, data from one or more data sources;
processing, by the AI agent, the data via one or more transforms in accordance with the execution plan; and
returning, by the AI agent, a result based on output produced by the one or more transforms.

2. The method of claim 1, wherein returning the result comprises presenting the processed data to the user.

3. The method of claim 1, wherein returning the result comprises dynamically building, by the AI agent, a graphical user interface to be displayed to the user.

4. The method of claim 1, wherein returning the result comprises dynamically generating, by the AI agent, at least one User Interface element to present to the user.

5. The method of claim 1, wherein returning the result comprises performing a computing action that requires a combination of application programming interfaces for applications.

6. The method of claim 1, wherein building the execution plan comprises recursively building the execution plan by:
building a high-level execution plan comprising a plurality of steps; and
recursively building an execution plan for each step in the plurality of steps.

7. The method of claim 1, further comprising providing the execution plan to the user.

8. The method of claim 7, wherein providing the execution plan to the user comprises providing a user interface that enables the user to modify the execution plan.

9. The method of claim 1, further comprising providing the one or more transforms configured to make the applications independent of LLMs and to provide stable and predictable behavior from the LLMs.

10. The method of claim 9, wherein providing the one or more transforms to the user comprises providing a user interface that enables the user to modify the one or more transforms.

11. The method of claim 1, wherein the one or more data sources comprise at least one application programming interface.

12. The method of claim 1, wherein building the execution plan comprises:
building a plurality of execution plans;
testing each execution plan in the plurality of execution plans; and
selecting a highest-performing execution plan as the execution plan.

13. The method of claim 12, further comprising storing the highest-performing execution plan.

14. The method of claim 1, wherein:
building the execution plan comprises generating computing code;
retrieving the data from one or more data sources comprises executing a portion of the computing code; and
processing the data via one or more transforms comprises executing an additional portion of the computing code.

15. A system comprising:
at least one physical processor;
physical memory comprising computer-executable instructions that, when executed by the physical processor, cause the physical processor to:
receive, by an AI agent, a query from a user;
process, by the AI agent, the query to derive an intent;
build, by the AI agent, an execution plan based on the intent;
retrieve, by the AI agent, in accordance with the execution plan, data from one or more data sources;
process, by the AI agent, the data via one or more transforms in accordance with the execution plan; and
return, by the AI agent, a result based on output produced by the one or more transforms.

16. The system of claim 15, wherein returning the result comprises presenting the processed data to the user.

17. The system of claim 15, wherein returning the result comprises dynamically building, by the AI agent, a graphical user interface to be displayed to the user.

18. The system of claim 15, wherein returning the result comprises dynamically generating, by the AI agent, at least one graphical element to present to the user.

19. The system of claim 15, wherein returning the result comprises performing a computing action.

20. A non-transitory computer-readable medium comprising one or more computer-readable instructions that, when executed by at least one processor of a computing device, cause the computing device to:
receive, by an AI agent, a query from a user;
process, by the AI agent, the query to derive an intent;
build, by the AI agent, an execution plan based on the intent;
retrieve, by the AI agent, in accordance with the execution plan, data from one or more data sources;
process, by the AI agent, the data via one or more transforms in accordance with the execution plan; and
return, by the AI agent, a result based on output produced by the one or more transforms.
